(19) United States
(12) Patent Application Publication
(10) Pub. No.: US 2009/0099046 A1
(43) Pub. Date: Apr. 16, 2009

(54) METHODS, DRILLING FLUIDS AND DRILLING FLUID ADDITIVES FOR LIMITING TAR SAND ACCRETION ON METAL SURFACES

(76) Inventors: Danny E. Procter, Calgary (CA); Kenneth Watts, Calgary (CA)

Correspondence Address: ADE & COMPANY INC., 2157 Henderson Highway, WINNIPEG, MB, R2G1P9, CA

(21) Appl. No.: 12/210,433

(22) Filed: Sep. 15, 2008

(30) Foreign Application Priority Data
Sep. 14, 2007 (CA) 2603201

(51) Int. Cl. C09K 8/22

(52) U.S. Cl. 507/131

(57) ABSTRACT

Drilling fluids, drilling fluid additives and methods for oil well drilling feature quaternary ammonium salts and act to reduce accretion of bituminous material on metal surfaces of drilling equipment.

This application claims foreign priority benefit from Canadian Patent Application No. 2,603,201 filed Sep. 14, 2007.

The invention relates to drilling fluids, drilling fluid additives and methods and for limiting accretion of tar sands on metal surfaces in bitumen or heavy oil drilling operations.

### BACKGROUND OF THE INVENTION

Oil sand deposits represent a vast source of relatively untapped bitumen reserves. A major problem encountered during drilling of bitumen rich deposits is that bituminous material or tar sand, due to its chemistry and high viscosity, accretes (or sticks) to drill components. For example, when drilling bitumen rich formations, bituminous material often accretes (or sticks) to the drill-string, Bottom Hole Assembly (BHA) or surface handling and solids control equipment. This forces operators to remove the accumulated bitumen, which results in the halting of drilling operations and a decrease in productivity.

As conventional drilling fluids by themselves are unable to prevent the accretion of bitumen to drill components, drilling fluids are often provided with additives that are used to counteract the accumulation of bitumen on drill components to avoid the use of operators' time in keeping elements of the drilling operation clean from bitumen accumulations.

U.S. Pat. No. 7,081,438 by Horton teaches the use of phosphonates or phosphate esters to offer improved performance in the prevention or limitation of bitumen accretion on metal surfaces of the drilling equipment over other additives previously used.

It has been found that the use of phosphates as anti-accretion additives may cause stripping of sand from the bitumen, which is counteractive to carrying of the sand to the surface of the well by the bitumen produced therefrom. Depending on how the waste stream handling systems are arranged at a drilling site, stripping of the sand from the bitumen may or may not be desirable.

### SUMMARY OF THE INVENTION

According to a first aspect of the invention there is provided an aqueous drilling fluid containing a tar sand anti-accretion additive comprising a quaternary ammonium salt.

Cationic ammonium salts have been found to have anti-accretion effects to prevent bituminous material accretion on metal surfaces while retaining the without stripping sand from the bitumen.

The additive may comprise different types of quaternary ammonium salts. In this instance, a ratio between the different types of quaternary ammonium salts may be based on content of the tar sand.

Preferably at least one quaternary ammonium salt in the additive is derived via epiamine chemistry.

Preferably each quaternary ammonium salt in the additive is derived via epiamine chemistry. Alternatively, one quaternary ammonium salt may be a polyDADMAC salt.

In a further embodiment the anti-accretion additive further comprises a phosphate-based tar sand accretion inhibitor. By using a phosphate-based inhibitor and cationic quaternary ammonium salt together in a drilling additive, the degree of bitumen stripping caused by the phosphate can be controlled by varying the ratio of the quaternary ammonium salt to the phosphate, as a coagulation effect of the salt counteracts the surfactant effects of the phosphate.

The phosphate-based tar sand accretion inhibitor may be a phosphonate.

Preferably the phosphate-based tar sand accretion inhibitor is anionic.

The drilling fluid may comprise a viscosifier, which may be anionic, non-ionic or cationic.

The viscosifier may be guar, cationic guar, hydroxyethyl cellulose, scleroglucan or wellan gum (slightly anionic viscosifier).

Preferably the quaternary ammonium salt is cationic.

According to a second aspect of the invention there is provided a drilling fluid additive comprising a quaternary ammonium salt.

According to a third aspect of the invention there is provided a method for limiting tar sand accretion on metal surfaces exposed to a tar sand formation through a wellbore extending theretoward, the method comprising exposing tar sand to an aqueous drilling fluid including an amount of at least one quaternary ammonium salt.

Preferably the method includes exposing the metal surfaces to a phosphate-based tar sand accretion inhibitor contained in the drilling fluid.

Preferably the steps of exposing the metal surfaces and exposing the tar sand are carried out by circulating the drilling fluid through the wellbore.

Preferably the steps of exposing the metal surfaces and exposing the tar sand are carried out during drilling of the wellbore.

### BRIEF DESCRIPTION OF THE DRAWINGS

Exemplary embodiments of the present invention will now be described in conjunction with the accompanying drawings in which:

FIG. 1 shows, from left to right, a 4144 drill collar and a metal bar of unknown composition prior to any exposure to tar sand.

FIG. 2 shows, from left to right, two metal bars of unknown composition hot rolling for 16 hours in water and bitumen, no additive having been added to the left sample and polyamine and polyDADMAC quaternary ammonium salts having been added to the right sample.

FIG. 3 shows three 4144 drill collars after hot rolling for 16 hours in water and bitumen, no additives having been added to the leftmost sample, but a polyamine quaternary ammonium salt and phosphate additive having been added to the other samples, the middle drill collar having been rolled in a glass jar and the rightmost drill collar having been rolled in a 303L stainless steel aging cell.

FIG. 4 shows two 303L stainless steel aging cells after hot rolling therein of two 4144 drill collars for 16 hours in water and bitumen with, from left to right, no additives and a polyamine and phosphate additive.

FIG. 5 shows a hypothetical interaction between a metal surface, represented by Fe²⁺ cations, and a phosphate-based inhibitor, represented by a generic phosphate.

FIG. 6 shows a hypothetical interaction between bitumen and a generic chloride-based quaternary ammonium salt.

FIG. 7 shows, from left to right, two metal bar and bitumen samples having been run in tap water, the left sample having had only phosphate added and the right sample having had phosphate and polyamine added.

### DETAILED DESCRIPTION

The present invention relates to a water-based drilling fluid designed and intended for use in oil (tar) sands, bitumen or heavy oil drilling applications.

In one embodiment, the system is comprised of two products that work synergistically together in order to obtain the desired effect of preventing accretion of the hydrocarbons (bitumen) on the drill string or other metal surfaces within the wellbore during the drilling thereof. The products used in this embodiment are quaternary ammonium salts and phosphate-based inhibitors. As is known from the prior art, the phosphate-based inhibitor is an anti-accretive agent. The quaternary ammonium salts may be polyamine salts of this type derived via epiamine chemistry or may be polydiallyldimethylammonium chlorides (polyDADMACs).

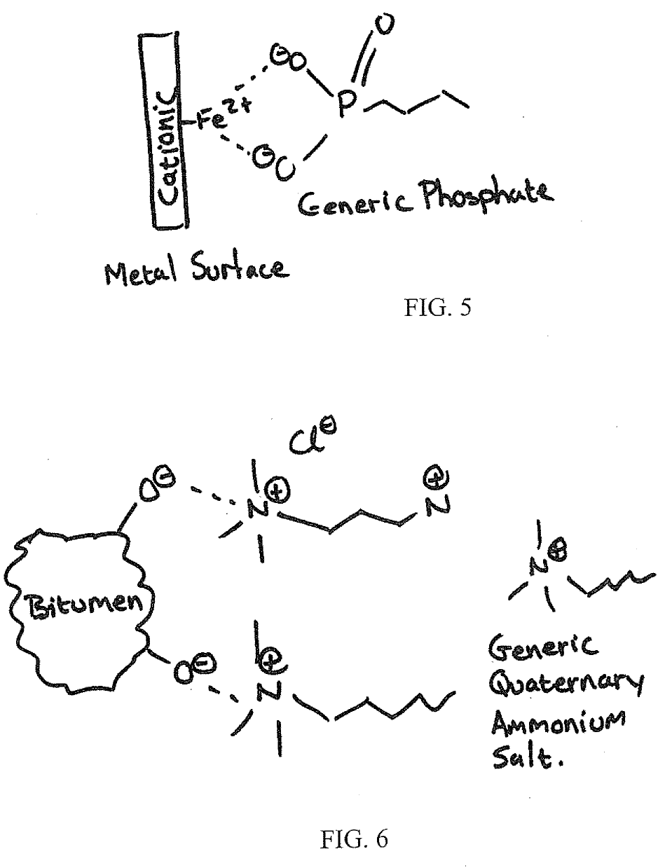

Without being bound to any particular theory or hypothesis, it is hypothesized that, as shown in FIG. 5, the phosphate-based inhibitor, if it is a phosphonate, binds to the metal surface of the drill string or other downhole equipment via a chelating effect, thereby preventing further oxidation of the metal surface and also preventing interaction of the cationic sites at the metal's surface with the anionic sites of the bitumen. If the phosphate is of a different type, it is hypothesized, without being bound to any particular theory or hypothesis, is that it will film on the metal surface to prevent corrosion by anodic inhibition. This effectively alters the metal surface as well and results in the same repulsion of the bitumen from the metal itself, as it alters the surface chemistry of the metal from its previously overall cationic nature to be non-interactive with the hydrocarbon (bitumen). In other words, controlling the metal surface via anodic inhibition, the phosphate binds to the cationic sites on the metal and creates a uniform surface, hypothesized, without binding the present invention to any particular theory or hypothesis, to be effective for all metal surfaces. Although iron (Fe²⁺) is shown at the metal surface in the figure, the composition and the oxidation sate of surface elements will vary, the phosphate being hypothesized, without binding of the present invention to any particular theory or hypothesis, to be effective regardless. The phosphate-based inhibitor thus has two functions: surface chemistry alteration and prevention of oxidative corrosion of the metal surface.

However the phosphate-based inhibitor has been found to have surfactant properties. In excess, the phosphate can act as a surfactant and disrupt the water layer between the bitumen and the sand in water-wet tar sands where the individual sand particles are surrounded by a thin film of water, which is in turn surrounded by a film of oil. This results in stripping or freeing of the sand from the bitumen, which may not be desirable depending on the type of waste stream management system is employed at a specific drilling operation, as some systems rely on the bitumen to carry the sand to the surface for subsequent separation.

It has been found that a drilling fluid additive containing both a phosphate-based inhibitor and quaternary ammonium salt not only prevents or limits accretion of bituminous material (tar sand) to the metal surfaces exposed thereto in the wellbore, but also reduces the degree of stripping of the sand from the bitumen relative to the use of the phosphate-based inhibitor without the salt. Without being bound to any particular theory or hypothesis, the mechanism hypothesized to provide this result is illustrated in FIG. 6. Bitumen is a large complex compound consisting of various hydrocarbons with an overall anionic charge. The quaternary ammonium salts used are cationic and thus bind through attractive interactions to the anionic functional groups on the bitumen. The quaternary ammonium salt neutralizes the negatively charged functional groups of the anionic component of the bitumen (apshaltenes and resins). This mechanism operating between the ammonium salts and the bitumen causes coagulation of the bitumen, which causes the structure of the bitumen to remain intact as a semi-solid with the sand still entrained in the bitumen, thereby countering the stripping effect of the phosphate-based inhibitor. This allows for ease of removal from the system allowing the water base fluid to be re-used. However, the concentrations of the product can be tailored for different results, ranging from consolidated bitumen to stripped bitumen depending on the client's desires or needs. In excess, the phosphate can act as a surfactant and disrupt the water layer between the bitumen and the sand. This results in stripping of the sand from the bitumen. The quaternary ammonium salt is used as a competitive reagent which, in sufficient quantities, will coagulate the bitumen prior to the surfactant potential of the phosphate being observed within formulation.

The goal of the quaternary ammonium salt and phosphate system is to prevent accretion on the metal surfaces of the well equipment as well as to prevent, or control, stripping of the sand from the bitumen. By varying the concentration of the cationic quaternary ammonium salts relative to the phosphate-based inhibitor to control the level to which the coagulation effect of the salts on the bitumen counters the surfactant effect of the phosphate, the operator can control the resulting consistency of the bitumen. Depending on how a client wishes to handle waste streams, for example whether or not the client wishes to have the sand remain within the bitumen for delivery to the surface therewith, the system can be altered to accommodate. The overall concentration of the drilling fluid additive containing the quaternary ammonium salts and the phosphate can be varied according to the amount and content of the bituminous material or tar sand in the wellbore in which the drilling fluid is circulated.

Furthermore, it has been found, by using the cationic quaternary ammonium salts without the phosphate-based inhibitor, that the salts themselves have an anti-accretion effect. Without being bound to any particular theory or hypothesis, it is hypothesized that this is because the binding of the cationic quaternary ammonium salts and the anionic functional groups on the bitumen results in charge neutralization and thus prevents binding of the bitumen to the metal, which otherwise would occur as the bitumen is predominantly anionic in nature while the exposed metal surface is cationic. Without this neutralizing effect of the quaternary ammonium salt, electrostatic attraction would occur at the anionic sites on the bitumen, causing bitumen to bind to the metal surface as it does when no anti-accretion additive is used in the drilling fluid.

In an alternate embodiment, the quaternary ammonium salts are added to the drilling fluid without a phosphate-based accretion inhibitor. In such an embodiment, more than one such salt can be used and it has been found that results can be improved by varying a ratio of the different types of quaternary ammonium salts according to the oil content. However, it has been found that although the use of cationic quaternary ammonium salts without the inclusion of the phosphate-based inhibitor in the drilling fluid additive will provide similar results initially, the phosphate free additive will eventually fail to prevent accretion after repeated exposure of the metal surface to bitumen while the phosphate and quaternary ammonium salt additive will continue to keep the a surface clean after the same level of exposure. This failure after a cumulative testing period may have been due to possible adsorption of asphaltenes to the surface of the metal causing nucleation sites that resulted in an uncontrollable metal surface. However, phosphate-free quaternary ammonium salt additive may still prove useful in applications of limited exposure to bitumen.

A number of cationic quaternary ammonium salt products have been tested, specifically polyDADMACs CP626 and CP645 available from HyChem and Zetag 7117, Zetag 7125, Zetag 7122 and Magnafloc 368 available from CIBA and epiamine chemistry derived quaternary ammonium salts CP753 and CP757 available from HyChem and Zetag 7122, 7125, 7197, 7183, 7181 available from CIBA. These tested ammonium salts have all proven to work as effective anti-accretive products; however the epiamine chemistry products in conjunction with the phosphate have proven the most effective. It is hypothesized that all quaternary ammonium salts should work by the same mechanisms.

Alpha 2296 drilling corrosion inhibitor available from Clearwater International LLC and AAA-101 available from Brine-Add Fluids Ltd. have been tested as phosphate-based inhibitors in the system and found to work well with the quaternary ammonium salts. Without being bound to any particular theory or hypothesis, it is hypothesized from the prior art that the phosphate-based inhibitor may be selected from phosphonates, phosphate esters of organic ligands, such as alkanolamines, or mixtures thereof, including the following phosphonates:

aminotrimethylenephosphonic acid (ATMP),

1-hydroxyethylidenediphosphonic acid (HEDP),

ethylenediaminetetramethylenephosphonic acid (EDTMPA),

diethylenetriaminepentamethylenephosphonic acid (DTPMPA)

bis(hexamethylenetriaminepentamethylenephosphonic acid (BHMTPMPA)

and mixtures thereof;

and the following phosphate esters

mono and di-phosphate esters of triethanolamine (TEAPE),

mono and di-phosphate esters of diethanolamine (DEAPE) and

mono and di-phosphate esters of monoethanolamine (MEAPE)

and mixtures thereof.

It is believed that other phosphate-based inhibitors may be effective used in conjunction with quaternary ammonium salt in a drilling fluid additive of the present invention.

The drilling fluid can be viscosified, with tests having been performed with the following types of viscosifiers: Xanthans, Guars (Non-ionic and Cationic), hydroxypropyl guars, hydroxyethyl celluloses, sepiolite, attapulgite clay, Wellan Gums, Locus gums and Scleroglucan. Hydroxyethyl celuloses and scleroglucan have so far resulted in the best performance of the drilling fluid, with Wellan Gums showing promise. Without being bound to any specific theory or hypothesis, anionic viscosifiers such as Xanthans are hypothesized to be detrimental to the performance of the quaternary ammonium salts, as they will interact with cationic polymers resulting in flocculation of the drilling fluid system therefrom and thus reduce interaction with the bitumen, but it is believed that viscosifiers other than those listed above may be used.

The system may also contain effective shale inhibitors of the polyamine nature to prevent shale from sloughing off and increase wellbore stability. These are compatible and effective in the presence of hydratable and dispersible clays. Additionally the shale inhibitor has an anti-accretive effect as well. However this is its secondary purpose. Hexamethylene diamine (HMDA) and tetraethylene pentamine (TEPA) have been tested and found to work well. No adverse effects to the anti-accretive and anti-stripping functions of the quaternary ammonium salts are expected with other non-ionic or cationic shale inhibitors, including other polyamides and polyacrylamides.

In testing, the concentration of the phosphate-based inhibitor has been varied between 0.1% and 1% by volume of the drilling fluid, but concentrations outside of this range may be applied. Effective concentrations of quaternary ammonium salt solutions are estimated to be between 0.1-10 L/m³, but concentrations outside this range may be applied. The drilling fluid containing the salt and phosphate additive or the salt-only additive may be circulated through the wellbore during drilling of the wellbore. It should be appreciated that the additive may not be required at all times during drilling, and fluid with the additive may be selectively used, for example only during times when the drill cuttings being produced contain tar sand.

A preferred embodiment of the drilling fluid additive has been produced using the following formulation: BioVis (scleroglucan) as the viscosifier, FL7 Plus or FL2 non ionic starch as a fluid loss agent, CP757 as the polyamine salt, Brine-Add AAA-101 as the phosphate-based inhibitor and TEPA as the polyamine as a clay stabilizer.

### Test Procedure

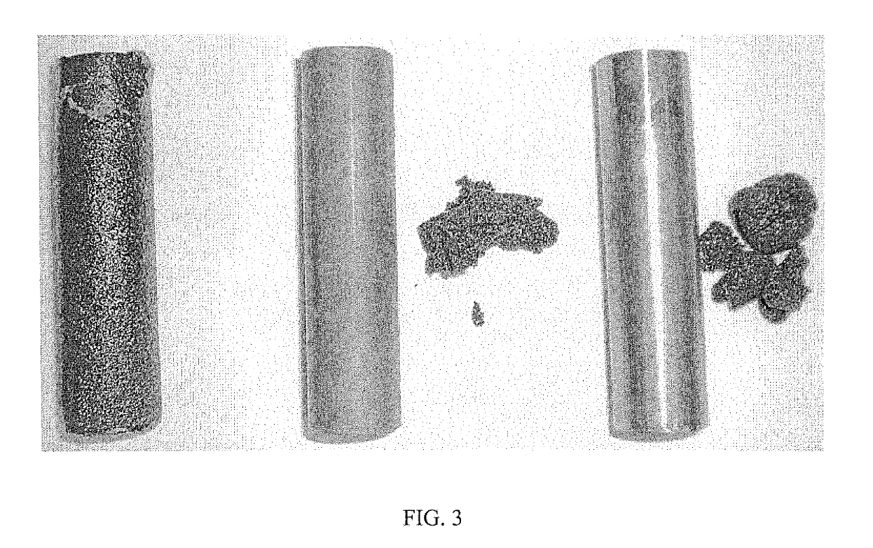

In the following examples, the following test procedures were used. Additives were mixed into 250 mL of tap water on a Hamilton Beach mixer at 10000 rpm for required dispersion/hydration time of formulation additives. Formulation rheology characteristics were determined by OFITE Model 900 rheometer. The solutions were then added to a glass mason jar or an aging cell of 303L stainless steel. Bitumen was added to but not mixed into the solutions and metal bars were then added, one per solution. In testing, metal bars designated 4144 Drill Collar metal were used, as were metal bars of unknown composition. The two bar types are shown in FIG. 3 prior to any exposure to the solutions. Samples were tested at 40 C (estimated bottom hole temperature) for 16 hr hot roll in either the glass jar or aging cell. The samples were then observed for degree of accretion, bitumen appearance (consolidated or stripped) and then the rheology of the fluid was again tested to determine effects of exposure of fluid to bitumen and metal.

### EXAMPLE 1

### Polymer Ratio vs. Bitumen Oil Concentration

Oil Concentration was determined by Dean Stark Analysis. The table below describes the amount each polymer solution used (expressed in litres per cubic meter of overall fluid) in an additive containing both a polyDADMAC and a polyamine quaternary ammonium salt for samples of bituminous material having different oil content percentages (the percentage of the total bituminous material that is oil).

TABLE 1
ratio of polymers to oil %

Polymer Ratio (L/m3)

| Oil % | PolyDADMAC | Polyamine |
|---|---|---|
| 16.0 | 1.00 | 0.25 |
| 13.7 | 1.00 | 1.00 |

From the table, it can be seen that an optimum ratio of 4:1 polyDADMAC to polyamine quaternary ammonium salt was found for a bitumen sample of 16% oil while a 1:1 ratio was better suited for a bitumen sample of 13.7% oil. The ratio is to be adjusted by oil content and testing as well as site conditions.

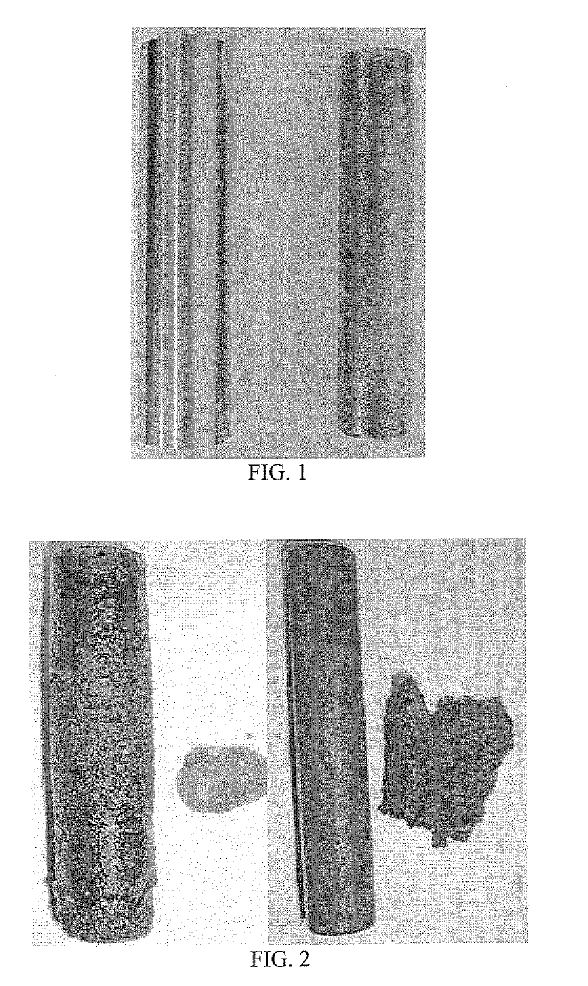

FIG. 2 shows, from left to right, a first metal bar of unknown composition and the bitumen it was exposed to with no additive, and a second metal bar of unknown composition and the bitumen it was exposed to with an additive including polyDADMAC and epiamine (polyamine) salts, but no phosphate-based inhibitor. After approximately 30 repeatable tests, the bar exposed to the additive has no visible accretion and the bitumen and sand are consolidated, while the bar exposed only to the bitumen and water has significant accretion and the bitumen came out tacky and sand-stripped (observed after each test). The system failed after cumulative testing period somewhere beyond the 30 test mark, possibly due to nucleation sites caused by possible adsorption of asphaltenes to the surface of the metal, resulting in an uncontrollable metal surface.

### EXAMPLE 2

### Polymer and Phosphate Combination (CP757 and AAA-101) vs. no Additive

FIG. 3 shows, from left to right, a first 4144 Drill Collar having been exposed to bitumen with no additive, a second 4144 Drill Collar and the bitumen it was exposed to in a glass jar with an additive including a polyamine salt (CP757) and a phosphate-based inhibitor (AAA-101), and a third 4144 Drill Collar and the bitumen it was exposed to in a stainless steel (303L) aging cell with the same additive as the second drill collar. After approximately 70 tests in the glass jar and approximately 5 or 6 tests in the aging cell the collars exposed to the additive have no visible accretion and the bitumen and sand are consolidated, while the bar exposed only to the bitumen and water has significant accretion and the bitumen came out tacky and sand-stripped.

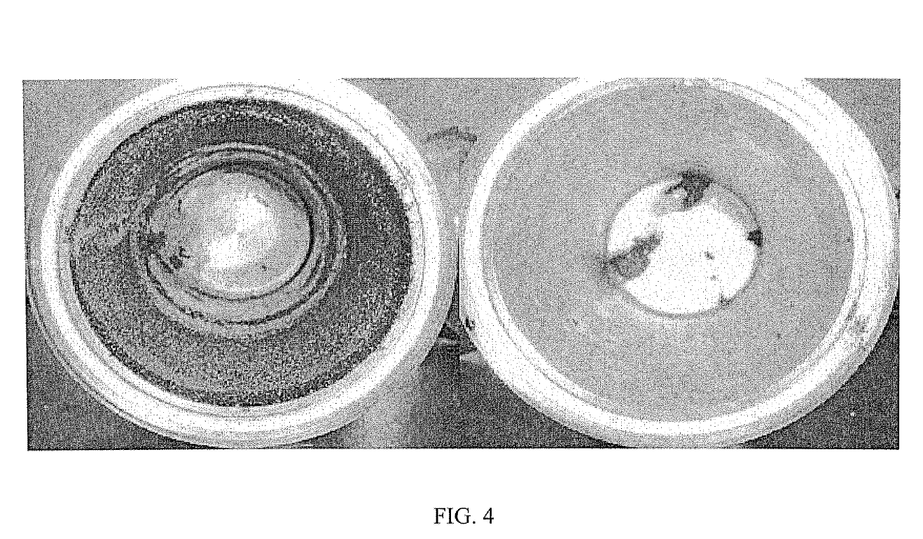

FIG. 4 shows, from left to right, a first stainless steel (303L) aging cell having been exposed to bitumen with no additive and a second stainless steel (303L) aging cell and the bitumen it was exposed to an additive including a polyamine salt (CP757) and a phosphate-based inhibitor (AAA-101). After approximately 5 or 6 tests, the second cell exposed to the additive has zero visible accretion and consolidated bitumen (with sand entrained), while the first cell exposed only to the bitumen and water has significant accretion and bitumen that appears tacky and sand-stripped.

Comparison of these drill collar metal results and those achieved for metal bars of unknown composition have shown comparable results for the phosphate and quaternary ammonium salt additive with samples of different metal compositions.

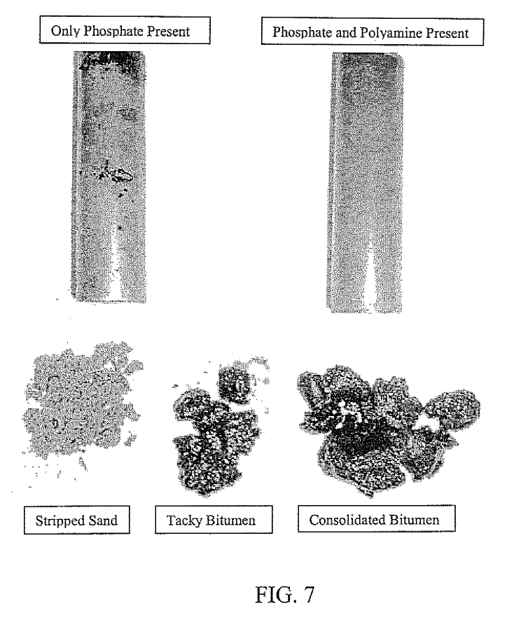

FIG. 7 shows, from left to right, a first metal bar having been exposed to bitumen with a phosphate-based inhibitor as the only additive, and a second metal bar having been exposed to bitumen with an additive made up of a polyamine salt and a phosphate-based inhibitor. It can be seen that the sample on the left has had some of the sand removed from the bitumen sample. Also an oily film is observed on the metal bar. The sample on the right shows a bitumen sample that is still intact and a metal bar that is clean.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An aqueous drilling fluid containing a tar sand anti-accretion additive comprising a quaternary ammonium salt.

2. The fluid according to claim 1 wherein the additive comprises different types of quaternary ammonium salts.

3. The fluid according to claim 2 wherein a ratio between the different types of quaternary ammonium salts is based on content of the tar sand.

4. The fluid according to claim 1 wherein at least one quaternary ammonium salt in the additive is derived via epiamine chemistry.

5. The fluid according to claim 1 wherein each quaternary ammonium salt in the additive is derived via epiamine chemistry.

6. The fluid according to claim 1 wherein one quaternary ammonium salt is a polyDADMAC salt.

7. The fluid according to claim 1 wherein the anti-accretion additive further comprises a phosphate-based tar sand accretion inhibitor.

8. The fluid according to claim 7 wherein the phosphate-based tar sand accretion inhibitor is a phosphonate.

9. The fluid according to claim 7 wherein the phosphate-based tar sand accretion inhibitor is anionic.

10. The fluid according to claim 1 further comprising a viscosifier.

11. The fluid according to claim 1 wherein the quaternary ammonium salt is cationic.

12. A drilling fluid additive comprising a quaternary ammonium salt.

13. The additive according to claim 12 further comprising a phosphate-based tar sand accretion inhibitor.

14. The additive according to claim 12 wherein the phosphate-based tar sand accretion inhibitor is anionic.

15. The additive according to claim 12 wherein the quaternary ammonium salt is cationic.

16. A method for limiting tar sand accretion on metal surfaces exposed to a tar sand formation through a wellbore extending theretoward, the method comprising exposing tar sand to an aqueous drilling fluid including an amount of at least one quaternary ammonium salt.

17. The method according to claim 16 wherein the step of exposing the tar sand is carried out by circulating the drilling fluid through the wellbore.

18. The method according to claims 16 wherein the step of exposing is carried out during drilling of the wellbore.

19. The method according to claim 16 further comprising exposing the metal surfaces to a phosphate-based tar sand accretion inhibitor contained in the drilling fluid.

20. The method according to claim 19 wherein the steps of exposing the metal surfaces and exposing the tar sand are carried out by circulating the drilling fluid through the wellbore.
